(19) United States
(12) Patent Application Publication
(10) Pub. No.: US 2012/0140054 A1
(43) Pub. Date: Jun. 7, 2012

(54) INTELLIGENT HAND WASHING MONITORING SYSTEM

(76) Inventors: Wen-Hui Chen, Taipei (TW); Yu-Hong Lin, Taipei (TW); Shun-jie Yang, Taipei (TW); Yi-Wen Yang, Taipei (TW)

(21) Appl. No.: 13/310,435

(22) Filed: Dec. 2, 2011

(30) Foreign Application Priority Data
Dec. 3, 2010 (TW) 099142030

(51) Int. Cl. H04N 7/18

(52) U.S. Cl. 348/77; 348/E07.085

(57) ABSTRACT

An intelligent hand washing monitoring system identifies if a user has actually washed every parts of his/her hands and informs the user with washed parts highlighted on a display unit. An image recognition technique is used to determine if the user uses a standard hand washing procedure to wash their hands and suggests to the user which part to wash with respect to the standard hand washing procedure in real time.

### BACKGROUND OF THE INVENTION

1. Field of the Invention

The present invention relates to a monitoring system, and more particularly, to an intelligent hand washing monitoring system which can detect hand washing gestures of a user and suggest that the user follow a standard hand washing procedure to correctly and efficiently clean his/her hands, thereby preventing infection, contagious diseases, and epidemics.

2. Description of the Prior Art

In recent years there have been several outbreaks of epidemics such as Enterovirus, Severe Acute Respiratory Syndrome (SARS), and H1N1 bird flu in Taiwan. Because the primary route of infection for these diseases is droplet or air-borne transmission, people usually wear face masks to prevent infection. However, they often ignore the fact that contact transmission could cause infection as well. There are two type of contact transmissions: direct contact and indirect contact. Direct contact means a person is infected by coming into contact with a carrier (patient), such as by shaking hands, body contact, etc. Indirect contact means a person is infected via a medium which is contaminated by the patient when the patient is transported or taken care of, or when the patient uses some public facilities. Infection by indirect contact is not easy to prevent and is often ignored, and the possibility of infection by indirect contact can be reduced by frequently washing hands.

Hand washing is a simple but effective way to prevent infection. Therefore, many organizations are dedicated to promote approaches to proper hand washing. Public-Private Partnership for Handwashing with Soap (PPPHW) proposed the first Global Handwashing Day on Oct. 15, 2008 to advocate the importance of hand hygiene. The Hand Hygiene Resource Center is a project of the Saint Raphael Healthcare System and John M. Boyce, M.D. The Center's mission is to advance the quality of patient care and reduce infection by improving hand hygiene practices in healthcare settings. In Taiwan, the Taiwan Joint Commission on Hospital Accreditation provides toolkits online for demonstrating and advocating hand hygiene practices. Many people are aware or will become aware of the importance of hand washing.

A correct way to wash hands to exterminate bacteria/viruses on the hands is illustrated in FIG. 1A. In order to help people wash their hand effectively and correctly, WHO has proposed this standard hand washing procedure. In Taiwan, the government announced a slogan, “wet, wipe, rub, hold and dry,” which comprises five steps of hand washing. The critical step is “rub”, as shown in the gestures of steps 2-7 in FIG. 1A.

These rub gestures are meant to help people notice the parts of hands which are often ignored in washing, such as nail slots, regions between the fingers, and some other parts which are hard to reach during the hand washing process, as shown in FIG. 1B.

Hence, it is important to advocate the benefits of hand washing and help people practice correct hand washing procedures. A hand washing recognition/monitoring system and hand washing system for people with dementia is applied to the problem.

As for hand washing recognition/monitoring systems, some systems require the user to wear a RFID reader to detect objects equipped with an RFID tag around the basin, in order to gather data of hand washing behavior. However, this approach fails to obtain detailed hand washing information and provides a low identification rate. Furthermore, users often refuse to wear RFID readers due to privacy concerns.

Another type of system adopts a computer vision approach, which uses image recognition to increase accuracy and to offer detailed information. The vision-based recognition approach generally deals with two recognition issues: 1. How to accurately obtain hand images, and 2. How to identify hand washing movements. Because the obtained hand images are often interfered with by splashed water, and because the hand images are often changed due to body movements and different viewing angles, it is not possible to identify hand washing movement simply by comparing patterns or skin color detection. Moreover, recognition techniques are usually based on gesture or trajectory. When the hand washing movement is not obvious enough to be classified as having any specific features, the recognition techniques often fails. Therefore, the current computer vision recognition system cannot effectively monitors hand washing movements.

Therefore, the prior-art technique presents some shortcomings to be overcome.

### SUMMARY OF THE INVENTION

In view of the deficiencies of the prior art techniques, it is an object of the present invention to provide an intelligent hand washing monitoring system which can detect hand washing gestures of a user and suggest that the user to follow a standard hand washing procedure to correctly and efficiently clean his/her hands.

It is an object of the present invention to provide an intelligent hand washing monitoring system. The intelligent hand washing monitoring system comprises an image capturing unit, a display unit; and an operation unit, wherein the operation unit comprises a hand image extracting unit, a dynamic detecting unit, an identifying unit, and a hand washing gesture classifier. The image capturing unit keeps monitoring the basin. When a user comes to the basin to wash their hands, the image capturing unit transmits a captured image to the operation unit. The operation unit then uses the hand image extracting unit to identify a hand image from the captured image, and uses the dynamic detecting unit to determine if the hand image is a hand washing gesture If not, the dynamic detecting unit keeps determining if another hand is in a hand washing gesture. If so, the identifying unit then compares the hand image with features provided by the hand washing gesture classifier and displays a corresponding suggestion on the display unit.

In the intelligent hand washing monitoring system disclosed in the present invention, the hand image extracting unit uses the background subtraction approach, the temporal differencing approach, the mean value approximation approach, or the combination thereof to identify a hand image from the captured image.

In the intelligent hand washing monitoring system disclosed in the present invention, the dynamic detecting unit uses the optical flow approach to determine if the hand is in a hand washing gesture.

In the intelligent hand washing monitoring system disclosed in the present invention, the intelligent hand washing monitoring system can be executed on a Microsoft Windows operating system.

As noted above, the intelligent hand washing monitoring system disclosed in the present invention can overcome the disadvantages of the prior art techniques and provides the following advantages:

1. The intelligent hand washing monitoring system can determine if a user has actually washed every parts of his/her hands and suggests that the user to follow the right procedures.

2. The intelligent hand washing monitoring system can successfully overcome the interference problem caused by splashed water.

3. The intelligent hand washing monitoring system does not require users to wear any kind of sensing devices and is viable to be deployed at any schools or educational institutes.

4. The intelligent hand washing monitoring system can be executed on a Microsoft Windows operating system, and can therefore provide the maximum compatibility with the current hardware devices and be widely adopted.

5. The intelligent hand washing monitoring system is the first to introduce computer vision recognition system into healthcare and epidemic control applications.

### BRIEF DESCRIPTION OF THE DRAWINGS

The drawings disclose an illustrative embodiment of the present invention which serves to exemplify the various advantages and objects hereof, and are as follows:

FIG. 1A illustrates a standard hand washing procedure provided by the World Health Organization;

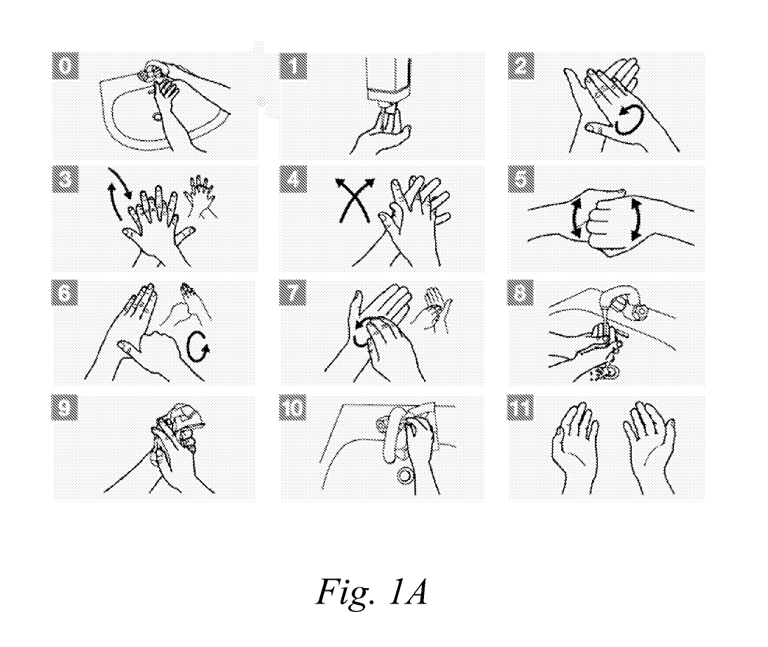

FIG. 1B illustrates hand parts are not easily cleaned in the hand washing process;

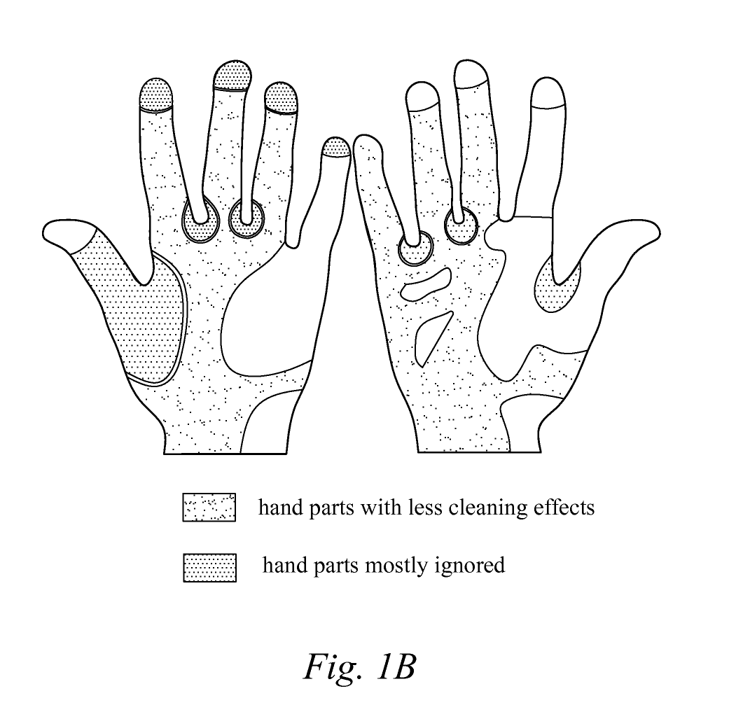

FIG. 2 illustrates an embodiment of the intelligent hand washing identifying system in the present invention;

FIG. 3 illustrates system modules of the intelligent hand washing identifying system in the present invention;

FIG. 4 illustrates a flowchart of the intelligent hand washing identifying system in the present invention;

FIG. 5A illustrates hand parts corresponding to the standard hand washing procedures;

FIG. 5B illustrates interface blocks of the intelligent hand washing identifying system in the present invention; and

FIG. 5C illustrates a partly enlarged view of the interface blocks of the intelligent hand washing identifying system in the present invention.

### REFERENCE NUMERALS

8 basin

10 intelligent hand washing identifying system

12 image capturing unit

14 display unit

16 operation unit

162 hand image extracting unit

164 dynamic detecting unit

166 identifying unit

168 hand washing gesture classifier

### DETAILED DESCRIPTION OF THE PREFERRED EMBODIMENT

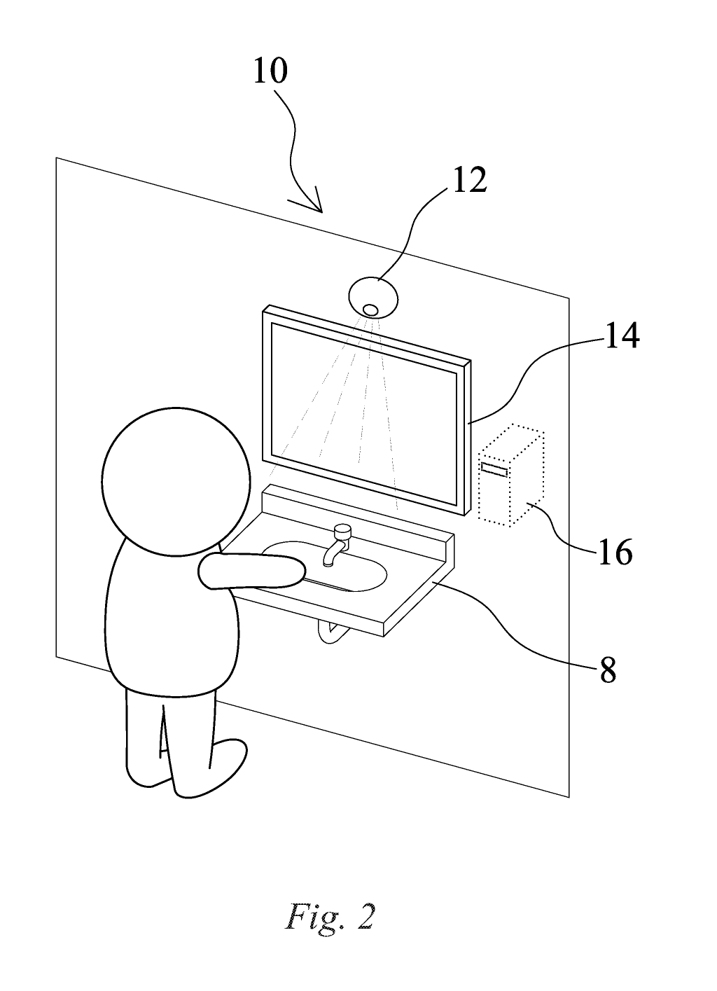

Please refer to FIG. 2 for an embodiment of the intelligent hand washing identifying system in the present invention. In this figure, the intelligent hand washing identifying system 10 comprises an image capturing unit 12, a display unit 14, and an operation unit 16. In this embodiment, the operation unit 16 and the display unit 14 are integrated and installed above the basin 8, and the image capturing unit 12 is installed above the operation unit 16 and the display unit 14. A user can come to the basin 8 to wash his/her hands.

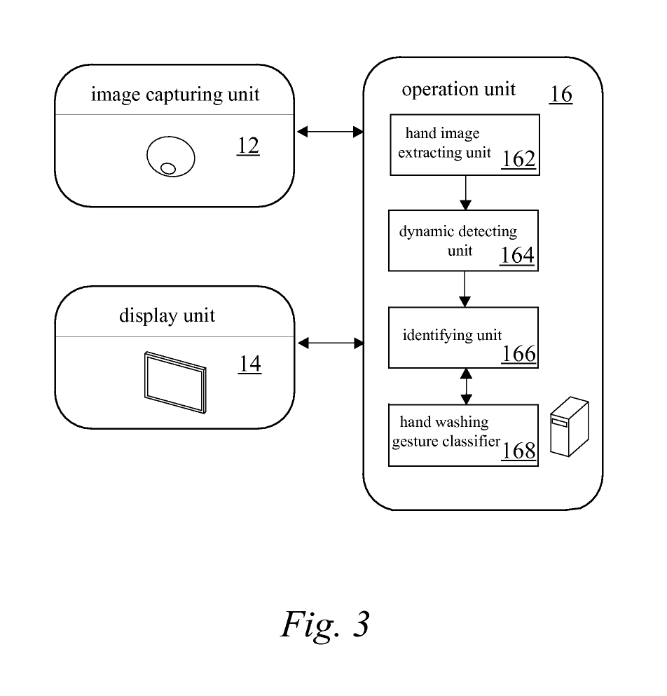

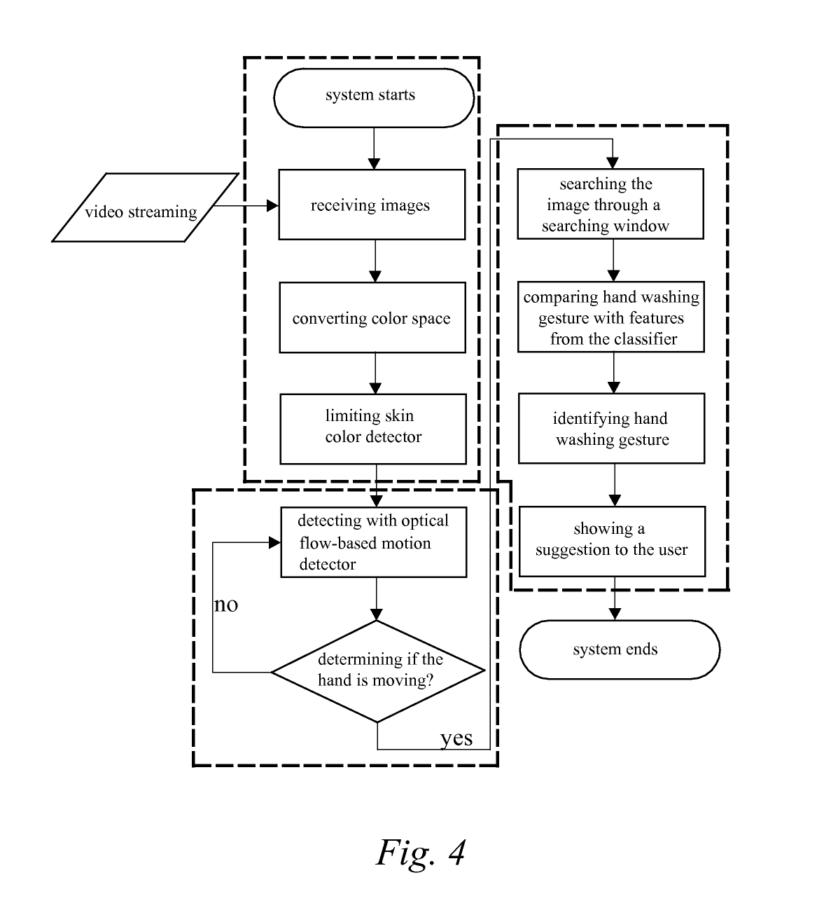

Please refer to FIG. 3 and FIG. 4. FIG. 3 illustrates system modules of the intelligent hand washing identifying system in the present invention, and FIG. 4 illustrates a flowchart of the intelligent hand washing identifying system in the present invention. In the figures, the intelligent hand washing identifying system 10 comprises an image capturing unit 12, a display unit 14, and an operation unit 16, wherein the operation unit 16 further comprises a hand image extracting unit 162, a dynamic detecting unit 164, an identifying unit 166, and a hand washing gesture classifier 168. Referring to FIG. 4, there can be three major steps for the operation flow of the system 10: which are: capturing hand parts, dynamic detection of both hands, and hand washing behaviors classification. First, the image capturing unit 12 captures images shown at the basin and the operation unit 16 uses the hand image extracting unit 162 to do color space conversion to reduce the influence of ambient light and to limit skin color areas to obtain hand images. Secondly, the operation unit 16 uses the dynamic detecting unit 164 to detect movements of the hands to determine if the user is washing his/her hands. When the system determines that the user is washing his/her hands, the system goes to the third step. In the third step, the operation unit 10 uses the identifying unit 166 to scan the image through a searching window and to compare the image in the searching window with features provided by the hand washing gesture classifier 168. If a value of the comparison result reaches a predefined threshold, the system determines the current hand washing movement and displaying a suggestion to the user.

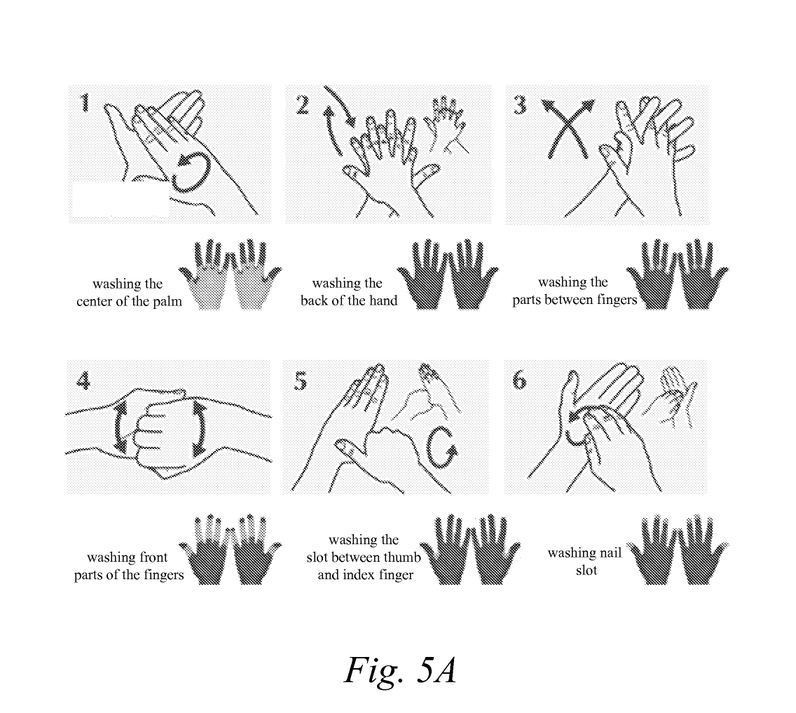

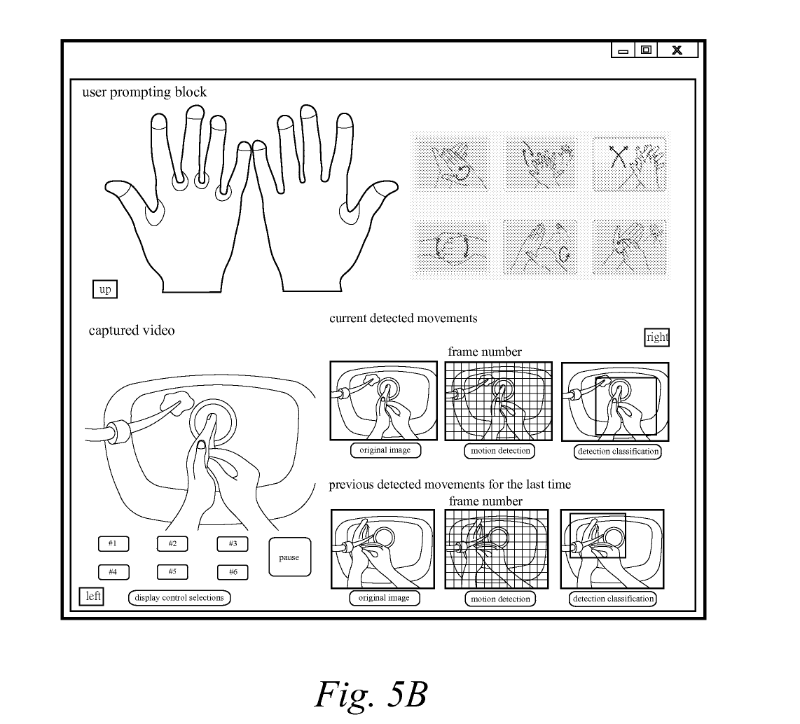

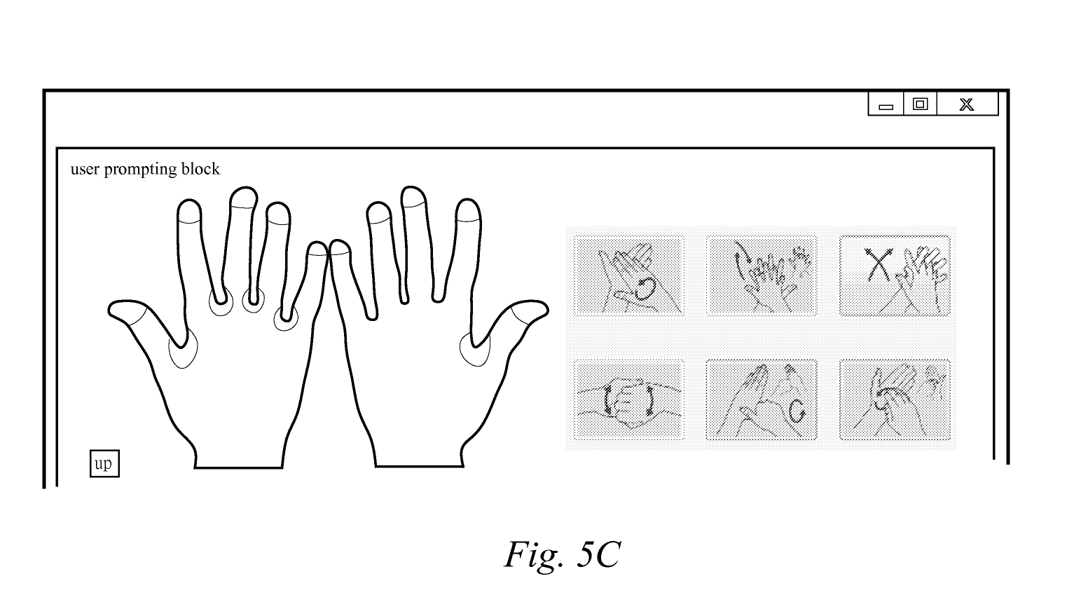

Please refer to FIG. 5A for hand parts corresponding to the standard hand washing procedures. In order to suggest the user which hand parts are to be washed, the system uses the display unit to show every detailed part of the hands. When a specific gesture is identified, the system will display a corresponding hand part to give suggestion, thereby helping the user know which hand parts are not washed yet and the hand parts corresponding to the standard hand washing procedures.

Please refer to FIG. 5B and FIG. 5C. FIG. 5B illustrates interface blocks of the intelligent hand washing identifying system in the present invention; and FIG. 5C illustrates a partly enlarged view of the interface blocks of the intelligent hand washing identifying system in the present invention. In FIG. 5B, the system interface is designed to have three blocks, i.e., an upper block, a left block and a right block. The upper block is a user prompting block for displaying standard hand washing procedures and unwashed hand parts with related control items. The left block is a video playback block for displaying real time video and related control items for video testing. The right block is an intermediate images information block for displaying processed images such as dynamically detected images and partitioned images based on skin color detection. Furthermore, as shown in FIG. 5C, the system can display only the upper block to the user in order not to disclose too much development information to the user.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An intelligent hand washing monitoring system comprising:
an image capturing unit;
a display unit; and
an operation unit comprising:
a hand image extracting unit;
a dynamic detecting unit;
an identifying unit; and
a hand washing gesture classifier;
wherein the image capturing unit continuously monitors the basin and, when a user comes to the basin to wash hands, the image capturing unit transmits a captured image to the operation unit,
wherein the operation unit uses the hand image extracting unit to identify a hand image from the captured image and uses the dynamic detecting unit to determine if the hand image is a hand washing gesture;
wherein, if the hand image is not a hand washing gesture, then the dynamic detecting unit keeps determining if another hand is in a hand washing gesture; and
wherein if the hand image is a hand washing gesture, then the identifying unit compares the hand image with features provided by the hand washing gesture classifier and displays a corresponding suggestion on the display unit.

2. The intelligent hand washing monitoring system as claimed in claim 1, wherein the hand image extracting unit uses a background subtraction approach, a temporal differencing approach, or a mean value approximation approach to identify a hand image from the captured image.

3. The intelligent hand washing monitoring system as claimed in claim 1, wherein the hand image extracting unit uses any combination of a background subtraction approach, a temporal differencing approach, and a mean value approximation approach to identify a hand image from the captured image.

4. The intelligent hand washing monitoring system as claimed in claim 1, wherein the dynamic detecting unit uses an optical flow approach to determine if the hand image is a hand washing gesture.

5. The intelligent hand washing monitoring system as claimed in claim 1, wherein the intelligent hand washing monitoring system can be executed on a Microsoft Windows operating system.
